(19) United States
(12) Patent Application Publication
(10) Pub. No.: US 2017/0022346 A1
(43) Pub. Date: Jan. 26, 2017

(54) METHODS USEFUL FOR RECOVERING POLYMERS FROM ELECTRONIC AND OTHER WASTES

(71) Applicants: Purdue Research Foundation, West Lafayette, IN (US); SABIC GLOBAL TECHNOLOGIES B.V., Amsterdam (NL)

(72) Inventors: George S. Weeden, JR., West Lafayette, IN (US); Nien-Hwa Linda Wang, West Lafayette, IN (US); Nicholas Soepriatna, West Lafayette, IN (US); Philip Bell, Mount Vernon, IN (US)

(21) Appl. No.: 15/159,149

(22) Filed: May 19, 2016

Related U.S. Application Data
(63) Continuation of application No. PCT/US2014/037824, filed on May 13, 2014.
(60) Provisional application No. 61/906,152, filed on Nov. 19, 2013.

(51) Int. Cl. C08J 11/08; C08G 64/40; C08G 64/00

(52) U.S. Cl. CPC C08J 11/08; C08G 64/00; C08G 64/406; C08J 2369/00

(57) ABSTRACT

Systems and methods for purifying or recycling polymeric materials such as polycarbonates are disclosed. Such methods may include performing two or more extractions using differing solvent media to remove non-target materials and attain a purified composition of a target polymer. Other steps including dissolution, precipitation, filtration, and/or centrifugation may also be performed in the methods of the present invention.

### REFERENCE TO RELATED APPLICATION

This application is a continuation of International Patent Application No. PCT/US2014/037824, filed May 13, 2014, which claims the benefit of priority of U.S. Patent Application Ser. No. 61/906,152 filed Nov. 19, 2013, each of which is hereby incorporated herein by reference in its entirety.

### BACKGROUND

The embodiments described herein relate generally to processes that are useful for recycling polymers, including for example polycarbonate polymers.

Polymers may be purified for a variety of reasons: for example, to reduce the need for petroleum-based feedstocks; and/or for recycling purposes to reduce the amount of non-biodegradable polymers disposed of in landfills. However, polymer purification may have drawbacks such as the low quality of purified polymer product relative to newly polymerized products; the need to add additional components such as plasticizers to purified polymer products; and the high cost of purification.

As one example, polycarbonates are a group of thermoplastic polymers, which can be easily molded or thermoformed and have high resistance to heat, chemicals, and impact. For these reasons, polycarbonates are widely used in electrical and electronic equipment. About 50 million metric tons of electronic waste is generated worldwide each year. Roughly a third of that weight is polymers, which can contain up to 100% polycarbonates. Polycarbonates may also be formulated with additional components to alter the properties of the polymer. Potentially, more than 2.5 million tons of polycarbonates can be recovered annually from electronic wastes. Presently, however, most recycling efforts concerned with electronic wastes deal with metals and glass, which are more valuable than the polymers.

In view of the background in this area, needs exist for improved and/or alternative methods for efficiently and cost-effectively recycling polymers, for example polycarbonate polymers occurring in electronic waste.

### SUMMARY

In certain aspects, the present disclosure relates to methods for recovering a purified polymer by subjecting the polymer, in a material also containing at least a first other component and a second other component, to processing with a first solvent medium to separate the first component from the polymer, and then subjecting the polymer, in a material also containing the second other component, to processing with a second solvent medium to separate the second other component from the polymer.

Beneficial embodiments are provided in methods for recovering a purified polymer composition that include contacting a first material including a polymer, a first component other than the polymer, and a second component other than the polymer, with a first solvent medium under conditions effective to attain a liquid-solid phase separation, for example but not limited to, extraction or precipitation of the first component from the polymer and the second component. The methods also include contacting a second material including the polymer and the second component with a second solvent medium different from the first solvent medium, under conditions effective to attain a liquid-solid phase separation of the second component from the polymer.

Additional beneficial embodiments are provided herein for recovering a purified polymer material by processing a multicomponent polymeric blend material including a polymer blended with a first component other than the polymer and a second component other than the polymer. Such recovery methods include agitating the multicomponent polymeric blend material in a vessel in contact with a first solvent medium under conditions effective to attain a liquid-solid phase separation of the first component from the polymer and the second component. The methods further include agitating a material including the polymer and the second component in a vessel in contact with a second solvent medium different from the first solvent medium under conditions effective to attain a liquid-solid phase separation of the polymer from the second component. The polymer can be recovered after the liquid-solid phase separation of the polymer from the second component.

In methods herein, the first solvent medium and/or the second solvent medium can be a mixed solvent medium containing a first organic solvent and a second organic solvent. In addition or in the alternative, methods herein may also include a processing step(s) to separate solid and liquid materials after the liquid-solid separations have been attained. Such step(s) may for example be performed by any one or a combination of filtration, decanting, distillation, centrifugation (including centrifuge decanting), or any other suitable means for separating liquid material from solid material.

In some modes of operation, the first phase separation attained results in a solid material that includes the polymer targeted for recovery (sometimes referred to herein as the “target polymer”), with the first component occurring in the liquid material. This first phase separation can occur from contact with a mixed solvent as discussed above and elsewhere herein. The second phase separation attained results in a liquid material that includes the target polymer, with the second component occurring in the solid material. Such a second phase separation can occur from contact with a solvent medium constituted of or essentially of only a single solvent, or of a mixed solvent. After separation of the target-polymer-containing liquid from the solid, the target polymer can be recovered from the separated liquid fraction. Recovery can for example be performed by one or any combination of precipitation (e.g., steam precipitation or by addition of an anti-solvent), solvent concentration, devolatization, distillation, or any other suitable technique or combination of techniques.

The foregoing and still further aspects and embodiments of the present disclosure will become apparent from the following detailed description and accompanying drawings.

### BRIEF DESCRIPTION OF THE DRAWINGS

FIG. 1 provides a process flow diagram for one illustrative embodiment of the present invention.

### DETAILED DESCRIPTION

Reference will now be made to certain embodiments and specific language will be used to describe the same. It will nevertheless be understood that no limitation of the scope of the invention is thereby intended, such alterations and further modifications, and such further applications of the principles of the embodiments as described herein being contemplated as would normally occur to one skilled in the art to which the descriptions relate.

As disclosed above, in certain of its aspects, the present disclosure relates to methods for the purification of polymers as, for example, may be used in polymer recycling or recovery processes. A purified polymer composition can be derived from a multicomponent polymer material, preferably a formulated (e.g., compounded) polymer blend, including a target polymer and other components (such as flame retardants, dyes and/or other polymers) by a method that includes at least, and potentially only, first and second extractions with first and second solvent media that differ from one another. In certain forms, the first solvent medium can be a mixed solvent medium, and the second solvent medium can be a mixed solvent medium or single solvent medium. Extraction with the first solvent medium can lead to a liquid-solid separation of the target polymer and at least a first of the other components, with the target polymer optionally residing in the solid phase. Extraction with the second solvent medium can lead to a liquid-solid separation of the target polymer and at least a second of the other components, with the target polymer optionally residing in the liquid phase. The target polymer can then be recovered, for example from the liquid phase when residing therein.

“Solvent medium” as used herein generally refers to a liquid solvent phase that may contain one or more solvents, preferably, solvents that are liquid at room temperature (about 25° C.) and atmospheric pressure (101.3 kPa). “Mixed solvent medium” as used herein generally refers to a liquid solvent phase that contains two or more different solvents, preferably solvents that are both liquid at room temperature and atmospheric pressure. “Binary solvent medium” generally refers to a liquid solvent phase that is constituted of or substantially constituted of only two different solvents. In this regard, “substantially constituted” as used herein to refer to a binary solvent medium or other solvent medium means that the specific solvent(s) identified provide the functional solvating capacity for materials in the process being undertaken with the solvent medium and/or that the specific solvent(s) identified constitute at least 95% by volume of the solvent medium (with other solvent(s) potentially occurring, for instance, as impurities in the identified solvent(s)).

Polymers suitable for purification herein include but are not limited to polycarbonates (PC) such as thermoplastic polycarbonates, bromopolycarbonates (Br—PC), styrene acrylonitrile polymers (SAN), acrylonitrile butadiene styrene (ABS) polymers, polyurethanes, and/or polymethylmethacrylate polymers (PMMA). These or other polymers to be purified can have any suitable molecular weight, for example, with a weight average molecular weight between about 2,000 Daltons and about 500,000 Daltons, between about 5,000 Daltons and about 250,000 Daltons, between about 5,000 Daltons and about 100,000 Daltons, or between about 10,000 Daltons and about 100,000 Daltons.

As used herein, a “polycarbonate” includes compositions having repeating structural carbonate units of formula (1).

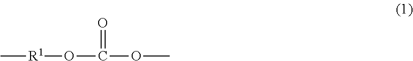

In some embodiments, at least 60 percent of the total number of R¹ groups contain aromatic moieties and the balance thereof are aliphatic, alicyclic, or aromatic. In one embodiment, each R¹ is a C₆₋₃₀ aromatic group, that is, contains at least one aromatic moiety. R¹ can be derived from a dihydroxy compound of the formula HO—R¹—OH, in particular of formula (2)

HO-A1-Y1-A2-OH (2)

wherein each of A1 and A2 is a monocyclic divalent aromatic group and Y1 is a single bond or a bridging group having one or more atoms that separate A1 from A2. In other embodiments, one atom separates A1 from A2. Specifically, each R¹ can be derived from a dihydroxy aromatic compound of formula (3)

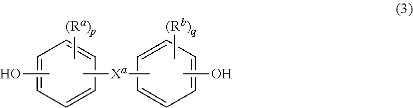

wherein R^{a} and R^{b} are each independently a halogen, C₁₋₁₂ alkoxy, or C₁₋₁₂ alkyl; and p and q are each independently integers of 0 to 4. It will be understood that R^{a} is hydrogen when p is 0, and likewise R^{b} is hydrogen when q is 0. Also in formula (3), X^{a} is a bridging group connecting the two hydroxy-substituted aromatic groups, where the bridging group and the hydroxy substituent of each C₆ arylene group can be disposed ortho, meta, or para to each other on the C6 arylene group. In another embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In an embodiment, p and q is each 1, and R^{a} and R^{b} are each a C₁₃ alkyl group, specifically methyl, disposed meta to the hydroxy group on each arylene group.

In yet another embodiment, X^{a} is a substituted or unsubstituted C3-18 cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene.

In a further embodiment, X^{a} is a C₁₋₁₈ alkylene group, a C₃₋₁₈ cycloalkylene group, a fused C₆₋₁₈ cycloalkylene group, or a group of the formula -B1-G-B2- wherein B1 and B2 are the same or different C₁₋₆ alkylene group and G is a C₃₋₁₂ cycloalkylidene group or a C₆₋₁₆ arylene group. For example, X^{a} can be a substituted C₃₋₁₈ cycloalkylidene of formula (4)

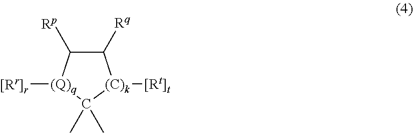

wherein R^{r}, R^{p}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)— wherein Z is hydrogen, halogen, hydroxy, C₁₋₁₂ alkyl, C₁₋₁₂ alkoxy, or C₁₋₁₂ acyl; r is 0 to 2, t is 1 or 2, q is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is 1 and i is 0, the ring as shown in formula (4) contains 4 carbon atoms, when k is 2, the ring as shown in formula (4) contains 5 carbon atoms, and when k is 3, the ring contains 6 carbon atoms. In an embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone.

“Polycarbonates” include, but are not limited to, homopolycarbonates (wherein each R¹ in the polymer is the same), copolymers comprising different R¹ moieties in the carbonate (“copolycarbonates”), copolymers comprising carbonate units, and other types of polymer units, such as ester units, and combinations comprising at least one of homopolycarbonates or copolycarbonates.

The target polymer may be present, for example, in a multicomponent polymer material such as that occurring as a waste stream or recycle stream from a waste removal vendor or recycler. The composition of the multicomponent polymer material need not be uniform, and may be a mixture of one or more polymeric materials mechanically mixed together. The polymeric material may for example, be reduced in size such as in the form of pellets or shredded material. In certain forms, the multicomponent polymer material will be a polymeric blend material in which the target polymer forms a unitary solid with other components, for instance as prepared by polymer compounding or other techniques. Multicomponent polymer materials suitable for use in the present invention include, but are not limited to, those recovered from electronic wastes. Such wastes may include other materials in addition to the multicomponent polymer material. Such other materials, which may be removed in the processes of the present invention, include as examples scrap metals, paper, glass, or other undesirable materials.

In one embodiment, a multicomponent polymer material to be used herein can contain a target polymer, for example, a polycarbonate polymer (PC), and can also contain: one or more organic flame retardant materials such as a brominated polymer (e.g., a Br—PC), a resorcinol diphenyl phosphate (RDP), or a bisphenol-A bis(diphenyl phosphate) (BPADP); one or more dyes, including organic dyes; one or more other polymers which may optionally be crosslinked polymer(s), such other polymer(s) potentially blended with the target polymer to provided modified mechanical properties, for example a SAN or ABS polymer or a polystyrene polymer (PS); one or more low molecular weight impurities (e.g., molecular weight less than 1,000 Daltons); mold release agents; UV stabilizers; glasses, anti-drip agents; impact modifiers; anti-oxidants; flame retardant synergists; heat stabilizers; quenchers; phosphate stabilizers; titanium dioxide; carbon black; pigments; talc; and/or other components.

The phosphorus-containing flame retardants in the polycarbonate-containing compositions include organic phosphates and organic compounds containing phosphorus-nitrogen bonds. One type of organic phosphate is an aromatic phosphate of the formula (GO)₃P═O, wherein each G is independently an alkyl, cycloalkyl, aryl, alkylaryl, or aralkyl group, provided that at least one G is an aromatic group. Two of the G groups can be joined together to provide a cyclic group, for example, diphenyl pentaerythritol diphosphite. Aromatic phosphates include, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like.

Aromatic phosphates include those in which each G is aromatic, for example, triphenyl phosphate, tricresyl phosphate, isopropylated triphenyl phosphate, and the like. Di- or polyfunctional aromatic phosphorus-containing compounds are also useful, for example, compounds of the formulae below:

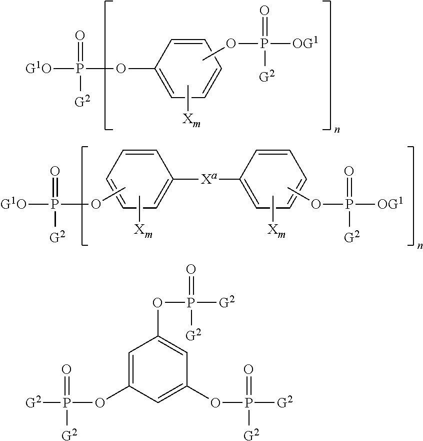

wherein each G¹ is independently a hydrocarbon having 1 to 30 carbon atoms; each G² is independently a hydrocarbon or hydrocarbonoxy having 1 to 30 carbon atoms; each X is independently a bromine or chlorine; m is 0 to 4, and n is 1 to 30. Di- or polyfunctional aromatic phosphorus-containing compounds include resorcinol tetraphenyl diphosphate (RDP), the bis(diphenyl) phosphate of hydroquinone and the bis(diphenyl) phosphate of bisphenol A, respectively, their oligomeric and polymeric counterparts, and the like.

Exemplary flame retardant compounds containing phosphorus-nitrogen bonds include phosphonitrilic chloride, phosphorus ester amides, phosphoric acid amides, phosphonic acid amides, phosphinic acid amides, and tris(aziridinyl) phosphine oxide. The organic phosphorus-containing flame retardants are generally present in amounts of about 0.1 to about 20 parts by weight, for example, about 2 to about 18 parts by weight or about 4 to about 16 parts by weight, optionally about 2 to about 15 parts by weight, based on 100 parts by weight of the total composition, exclusive of any filler.

As part of the purification, the multicomponent polymer material including the target polymer is contacted with a first solvent medium to attain a liquid-solid phase separated material. In certain embodiments, the first solvent medium can be a mixed solvent medium including two or more organic solvents, and these solvents and their relative amounts can be varied depending on the specific multicomponent polymeric material to be processed. The ratio of multicomponent polymeric material solids to first solvent medium in this contacting step may be any suitable ratio, for example in the range of about 1:50 to about 1:1 by weight, or more preferably about 1:20 to about 1:2 by weight. During this step of contacting with a first solvent medium, in certain embodiments, the target polymer and the second component remain in the solid material and the first component is solvated in the liquid material, while in other embodiments the target polymer and the second component are solvated in the liquid material and the first component remains in the solid material. In a subsequent step, a material including the target polymer and the second component is contacted with a second solvent medium different from the first to attain a liquid-solid phase separated material. In some variants, contact with the second solvent medium can provide a solid phase material including the target polymer and a liquid phase material including the second component, while in others, contact with the second solvent medium can provide a liquid phase material including the target polymer and a solid phase material including the second component. The material contacted with the second solvent medium can be a solid material, for example a recovered solid material resulting from the step of contacting the multicomponent polymeric material with the first solvent medium, or a solid material derived from such a recovered solid material. The liquid phase material including the target polymer (in solvated form) can then be processed to recover the target polymer, for example by precipitation to a solid and separation of the solid from any solvent medium remaining. The recovered solid can then be washed as needed or desired. In preferred forms, the process is conducted so as to result in a recovered solid product that is constituted at least 90% by the target polymer by weight.

Precipitations of target polymers or other components performed in embodiments herein can be conducted using any suitable technique or techniques. These include for example, addition of an anti-solvent to a liquid phase solvating the target polymer or other component to be precipitated, steam precipitation, evaporative, or other techniques.

In addition to recovery of a purified composition of the target polymer, the first, second and/or other components separated from the target polymer can be recovered in a purified form suitable for re-use. This can involve optional steps performed on either the liquid phase or the solid phase materials resultant of contact with the first solvent medium or second solvent medium and containing the component(s) to be purified.

In processes described herein, separations of liquid phase materials from solid phase materials can be accomplished by any suitable technique or techniques. These include, for example, one or more of filtration, decanting, distillation, or centrifugation (including centrifuge decanting). As well, drying steps (if any) for recovered solids can be accomplished by any suitable drying technique or techniques including for example one or any combination of air drying, heated drying, or flow of a gas against the solid material.

The ratio of the solids to solvent medium during contact with the first solvent medium can vary in accordance with the particulars of the process and materials at hand. In certain embodiments, such ratio is in the range of about 1:50 to about 1:1, more typically in the range of about 1:20 to about 1:2. Similarly, the ratio of the solids to solvent medium during contact with the second solvent medium can vary. In certain embodiments, such ratio is in the range of about 1:50 to about 1:1, more typically in the range of about 1:20 to about 1:2. Also, in preferred modes of operation, the contacting with a first solvent medium and the contacting with a second solvent medium are performed at substantially the same temperature, for example a temperature within about 10° C. of each other; and/or these contacting steps are preformed at ambient temperature, e.g., between about 20° C. and about 28° C. In some embodiments, where materials are contacted with a solvent system, for example but not limited to, a solid being contacted with a solvent medium such steps may be performed between 5° C. and 35° C. In other more preferred embodiments, such steps may be performed between 15° C. and 30° C. In other embodiments, where materials are contacted with a solvent system, for example but not limited to, a solid being contacted with a solvent medium such steps may be performed between 0.5 atm and 350 atm. In preferred embodiments, such steps are performed between 1 atm and 10 atm. Where more than one such contacting steps are performed in a method, the steps are preferably performed within 10 atm of each other.

Further, after separation from solids, solvents used in embodiments of the present invention can be recycled and re-used. Such recycle and re-use may or may not involve the purification of a solvent or co-solvents prior to re-use.

In certain embodiments using a preferred multicomponent polymeric material containing a polycarbonate as the target polymer, SAN, PS, RDP, dyes, flame retardants, and/or other low molecular weight impurities may move from the solid phase to the liquid phase during contact and extraction with the first solvent medium. The solid phase material in the attained liquid-solid phase separated material can include the target polycarbonate, Br—PC, ABS, and potentially also PVC. During and/or after the contacting step with the first solvent medium, the solid phase and the liquid phase materials can be separated from one another. After separation from the liquid phase, the solid phase materials including the polycarbonate can be washed with a suitable liquid, for example with the first solvent medium or another solvent medium. The solid phase materials can optionally be dried to remove residual solvent and/or wash medium. The recovered solid phase material, or a material derived from the recovered solid phase material and including at least the target polycarbonate and one or more of the Br—PC, ABS, and PVC, can then be contacted and extracted with a second solvent medium different from the first solvent medium to attain a liquid-solid phase separation of the target polycarbonate, in which the polycarbonate resides in the liquid phase, and one or more of the Br—PC, ABS, and PVC reside in the solid phase. During and/or after the contact and extraction with the second solvent medium, the attained liquid phase materials can be separated from the attained solid phase materials. After separation from the solid phase materials, the liquid phase materials including the polycarbonate can be processed to recover the polycarbonate, for example by precipitation using any suitable technique, including but not limited to those identified herein. The liquid phase material including the polycarbonate, in some modes of operation, also includes Br—PC, at least some of which is recovered in the polycarbonate composition. In preferred modes of operation, the target polycarbonate is recovered in a solid composition constituted at least 90% by weight (dry) of the target polycarbonate, more preferably at least 95% by weight, and even more preferably at least 97% by weight. Residual materials other than the target polycarbonate, if present, can include Br—PC.

In certain preferred embodiments for recovering a target polycarbonate, the first solvent medium can be a binary or other mixed solvent medium that includes dichloromethane and another solvent, preferably acetone, and the second solvent medium can be a binary or other mixed solvent medium including dichloromethane and another solvent or solvents, or a solvent medium constituted or substantially constituted of dichloromethane.

Suitable solvents for use in embodiments of the present invention include halogenated solvents including but not limited to dichloromethane (DCM), chloroform, carbon tetrachloride, 1,2-ethylene dichloride, 1,1,2,2-tetrachloroethane, chlorobenzene, and/or dibromomethane; 1,4-dioxane; tetrahydrofuran (THF); aniline; N-methyl-2-pyrrolidone; dimethyl acetamide; alcohols including but not limited to phenol, methanol, ethanol, glycerol, propanol, and/or isopropanol; carbonyl containing solvents including but not limited ketones or aldehydes, e.g., acetone (ACE), benzaldehyde, ethyl acetate, methyl ethyl ketone, and/or cyclohexanone; alkanes including but not limited to n-hexane, hexanes, pentane, n-heptane, octane, nonane, and/or decane; aromatic solvents including but not limited to benzene, toluene, phenol, aniline and/or mesitylene; acetonitrile; and/or combinations thereof.

Any suitable method can be used to select solvents for use in methods of the present invention. For example, Hansen solubility parameters (HSP) may be used to select suitable solvents. HSP consider many interactions between solvent and solute, for example dispersion interactions, polar interactions, and/or hydrogen bonding interactions and can be used to calculate the relative energy difference (RED) of the system. Mixed solvents used in embodiments herein will generally contain a stronger solvent for the polymer, preferably one that readily dissolves the target polymer, and a weaker solvent for the target polymer, preferably one that does not dissolve an appreciable amount of the target polymer. In some embodiments herein, a mixed solvent medium will include a stronger solvent and a weaker solvent for the target polymer, where the stronger solvent has the capacity to dissolve at least 10 times the amount by weight of the target polymer per unit volume of solvent as compared to the weaker solvent at 25° C. When a polycarbonate is the target polymer, stronger solvents for use in embodiments of the present invention include, but are not limited to, halogenated solvents including but not limited to dichloromethane (DCM), chloroform, carbon tetrachloride, 1,2-ethylene dichloride, 1,1,2,2-tetrachloroethane, chlorobenzene, and/or dibromomethane; 1,4-dioxane; tetrahydrofuran (THF); aniline; N-methyl-2-pyrrolidone; dimethyl acetamide; aromatic solvents including but not limited to benzene, toluene, phenol, aniline and/or mesitylene; and/or combinations thereof.

When a polycarbonate is the target polymer, weaker solvents for use in embodiments of the present invention include, but are not limited to; dimethyl acetamide; alcohols including but not limited to phenol, methanol, ethanol, glycerol, propanol, and/or isopropanol; carbonyl containing solvents including but not limited to ketones and aldehydes such as acetone (ACE), benzaldehyde, ethyl acetate, methyl ethyl ketone, and/or cyclohexanone; alkanes including but not limited to n-hexane, hexanes, pentane, n-heptane, octane, nonane, and/or decane; aromatic solvents including but not limited to benzene, toluene, phenol, aniline and/or mesitylene; acetonitrile; and/or combinations thereof. Stronger and weaker solvents are preferably miscible in one another to form a unitary liquid phase for the mixed solvent medium. For example, suitable binary or other mixed solvent systems may comprise a volumetric ratio of a stronger solvent to a weaker solvent in the range of about 9:1 to about 1:9, or in the range of about 7:3 to about 3:7.

Chromatography may also be used to determine suitable solvents. For example, gradient polymer elution chromatography (GPEC), high performance liquid chromatography (HPLC), flash chromatography, or thin layer chromatography (TLC) may be used. Chromatographic methods may include the use of more than one solvent, for example, a strong solvent and a weak solvent with respect to a given polymer used together as co-solvents, and the ratio of strong solvents to weak solvents with respect to a given polymer may be altered for example by a gradient or solvent ramp. When screening solvents by chromatography, solubility or insolubility of the polymer in a solvent medium is an important consideration as well as the resolution of polymers and/or the resolution of other impurities to be removed. Any suitable detector may be used during chromatographic methods, for example, but not limited to ultraviolet (UV) radiation detector, visible (VIS) radiation detector, a combination of the two as in a UV/VIS detector, refractive index (RI) detector, infrared (IR) radiation detector, dynamic light scattering (DLS) detector, evaporative light scattering (ELS) detector, or any other suitable detector or combination thereof.

The steps of contacting with a first and second solvent medium described herein can be performed as liquid-solid extractions. Such extractions may be performed, for example, as continuous extractions and/or batch extractions, and can have any partitioning coefficient between the liquid and solid phases. Extractions may be performed in a vessel with or without mechanical mixing. Such a vessel may be a general purpose vessel, for example but not limited to a tank or other vessel, or may be purpose-built to perform extractions.

The purified polycarbonate or other target polymer compositions prepared by processes herein can be put to use in any known manner. For example, the purified polycarbonate or other target polymer can be blended with other components, such as those other components identified herein, to form a new multicomponent polymeric composition, which can then itself be used in the manufacture of polymeric articles by extrusion, molding, thermoforming, or other shaping processes. These recovered purified compositions and downstream processes of use and resultant articles also form embodiments disclosed herein.

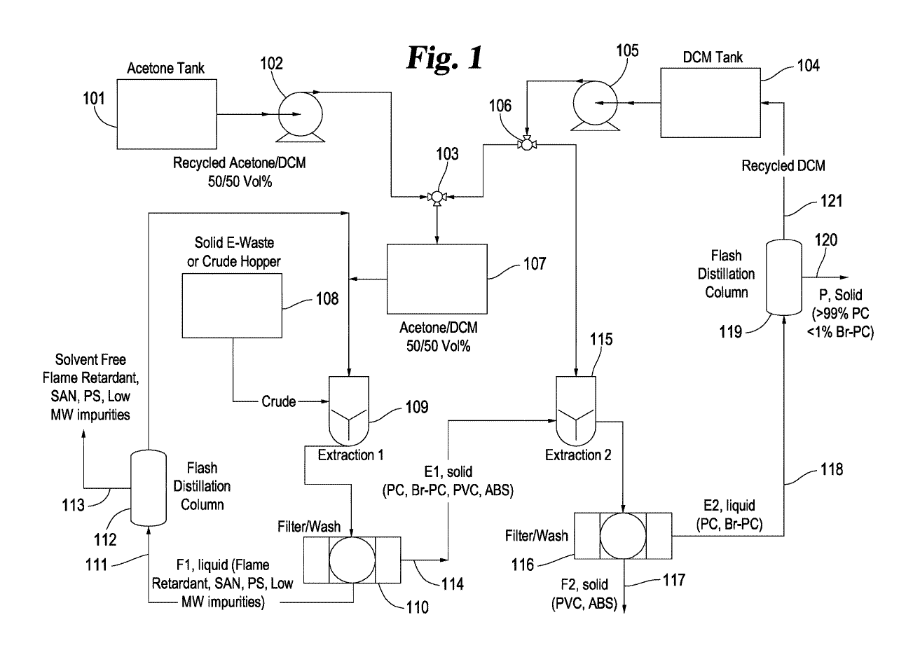

With reference now to FIG. 1, provided is an illustration of certain specific embodiments of the present invention. In these embodiments a solvent such as acetone from tank 101 is pumped through pump 102 and valve 103 to tank 107 to form a mixture of solvents, for example but not limited to, a mixture of acetone in dichloromethane. A solvent such as dichloromethane is pumped from tank 104 through pump 105 and valves 106 and 103 to tank 107. A polymer stream, such as solid electronic waste or crude material (e.g., a polycarbonate-containing material) is moved from storage tank 108 to extraction vessel 109 where a first solid-liquid extraction is performed with agitation. The extraction performed in tank 109 with a first solvent medium, for example a binary acetone/dichloromethane solvent medium in a 1:1 volumetric ratio, gives a solid that is filtered and/or washed in vessel 110 to leave a solid 114 that may comprise a polymer with or without additional impurities. This solid 114 may, for example, comprise polycarbonate, Br—PC, PVC and ABS, and a liquid 111 may comprise other polymers or impurities, for example, flame retardants, SAN, PS, dyes, and/or other low molecular volume impurities. Liquid 111 is passed through a flash column 112, to give impurities, for example, flame retardants, SAN, PS, dyes, and other low molecular volume impurities free of solvent as 113 and solvent that is recycled or re-used for use in additional extractions. Solid 114 is transferred to extraction vessel 115 where a second extraction is performed with agitation using a second solvent medium, for example, constituted or substantially constituted of dichloromethane added through valve 106. This second solid-liquid extraction is performed to leave a solid fraction that is filtered and/or washed in 116 to give solid 117 which contains other polymers or impurities, for example, PVC and ABS. The liquid fraction of this extraction gives a liquid 118 that contains a target polymer, for example, polycarbonate and may contain other impurities, for example, Br—PC dissolved in solvent.

Solvent recovery, for example, flash distillation, is performed in vessel 119 to give a solid precipitate 120 that comprises the target polymer, for example polycarbonate, in certain forms >99% by weight polycarbonate and <1% by weight Br—PC. The solvent 121, such as dicloromethane, from distillation is then recycled and transferred to tank 104.

For the purpose of promoting a further understanding of the principles of certain embodiments herein and their attendant features and advantages, the following specific Examples are provided. It will be understood that these Examples are illustrative, and not limiting, of broader aspects of the present disclosure.

### Example 1

### Recycling of Polycarbonate-Containing Polymer Formulations Through a Multi-Step Extraction Procedure

### Materials and Methods:

Pure standards of Polycarbonate (PC), brominated polycarbonate (BrPC), styrene acrylonitrile (SAN), polystyrene (PS), resorcinol bis-diphenylphosphate (RDP), and bisphenol A bis-(diphenyl phosphate) (BPADP) were obtained from SABIC Innovative Plastics (SABIC-IP) in Mt. Vernon, Ind. RDP and BPADP are blended with polymers for their flame retardant properties. An electronic waste mixture with high PC content, defined as the 70% PC crude here, was also obtained from SABIC-IP. Another type of crude polymer waste which is more commonly available from recyclers was provided by SABIC-IP and was given the designation “Trommel crude” based on the type of separation used at the recycling facility.

Tetrahydrofuran (THF) was obtained from Aldrich chemical company, Milwaukee, Wis., USA. Acetonitrile (ACN) was obtained from Mallinckrodt Baker, Inc. from Phillipsburg, N.J., USA. Dichloromethane (DCM) and acetone (ACE) were obtained from Macron Fine Chemicals, US. All solvents were >99.5% pure.

Centrifugation was performed with a Beckman Coulter Allegra 21 series centrifuge. Mass measurements less than 200 g were performed on a Mettler Toledo NewClassic MF. Mass measurements greater than 200 g were performed using a Denver Instrument XL-3100.

Chopping and/or size reduction of the solid waste was performed by adding the polymer waste into a Cuisinart blender and blending on low for 10 minutes. The blender was then emptied onto a stack of two sieves. Particles less than 250 microns fell through both sieves and were discarded. Solid particles between 250 and 850 microns were collected on the 250 micron sieve. Particles larger than 850 microns were sent back to the blender for further size reduction.

Extractions were performed in jars having a size of approximately 400 mL. The solid waste and solvent medium were added to the jars in a ratio of 15.1 g solid waste per 45.8 g of solvent medium. The tight seals of the jars were ideal when dealing with solvents with high vapor pressures (ACE and DCM). All extractions were continuously stirred at 50-150 rpm at (20±1) ° C. in the fume hood. Unless otherwise stated, extractions were left overnight and sampling occurred the next day.

Filtration of the solids from the liquid after extractions was performed by pouring the solution into a ceramic Büchner funnel lined with filter paper with 40 am pores. The liquid was allowed to pass through the filter paper and drip through the funnel into a beaker. The solids remaining in the funnel were rinsed with clean solvent having about the same composition as the solvent used in the extraction procedure in order to remove any inter-particle solution contaminated with dissolved polymers.

Centrifugation was achieved by collecting samples of approximately 10 mL into glass vials with screw caps. These vials were placed in the centrifuge and spun at 8,000 rpm for 30 minutes.

Precipitation was accomplished by addition of an anti-solvent or weak solvent to a polymer rich solution. For the present example, the polymer starts out dissolved in DCM. Addition of acetone to the solution causes precipitation of the polymers. Since PC is the desired polymer, acetone was added until the composition was about 50/50 (by volume) DCM/ACE. The solutions were stirred for at least one hour to allow for complete precipitation.

DCM is a strong or very good solvent for the major polymers in electronic waste and is relatively inexpensive. ACE is a relatively inexpensive weaker solvent or anti-solvent for the polymers. ACE and DCM are also fairly easy and inexpensive to recover via distillation due to their low boiling points. It is desirable to use these two solvents for the aforementioned reasons. In principle, HPLC analysis using a linear gradient of ACE and DCM can be used to find the potential mixed solvent compositions for the separation of PC and Br—PC from the other polymers. However, the UV absorbance of acetone drowns out the signal from the polymers over a wide range of wavelengths. For this reason, the standard HPLC method of determining the solvent composition for extraction or precipitation, using UV-based readout, was not used. Differential solubility was determined by placing pure polymer standards in different DCM/ACE compositions and visually observing whether any dissolution occurred. The results are shown in Table 1.

TABLE 1
Solvent compositions suitable for dissolution
of “70% Crude” polymer sample.

| | Solvent |
|---|---|
| | Composition |
| Solute | DCM/ACE |
| Br-PC | >50/<50 |
| PC | >85/<15 |
| SAN | <50/>50 |
| RDP | <50/>50 |
| BPADP | <50/>50 |

The major polymer constituents present in the 70% PC crude, other than PC and ABS, dissolve at a solvent composition of about 50/50 by volume DCM/ACE. Since PC does not dissolve until at least 85 volume percent DCM and ABS is insoluble in DCM, the DCM/ACE solvent pair with a composition from 50/50 to 84/16 percent by volume can be used to extract all the other polymers from the crude, leaving behind a solid containing PC and ABS. In a second step, binary DCM/ACE mixtures with a composition from about 100/0 to about 85/15 by volume can be used to extract pure PC from the residual solid from the first extraction step. The PC in the second extract can be precipitated and further purified by adding ACE (anti-solvent). Alternatively, the second extract can go through a steam precipitation or other devolatilization process step to recover solid PC and the solvents (ACE and DCM) can be recycled.

The 250-850 micron particles (15.1 grams) are placed in 45.8 g binary DCM/ACE solvent medium at a 50:50 volumetric ratio. In this solvent composition, many of the polymer impurities are extracted. These polymer impurities include RDP, BPADP, SAN, and some low molecular weight PC. BrPC and PC are not dissolved to any appreciable extent. BrPC was expected to be extracted at this point, but does not appear in solution. BrPC may form aggregates with PC which cannot be removed until the PC dissolves. This appears to be the case since BrPC is found in the solution of the second extraction.

After the first extraction has finished, the solid particles were washed with clean binary DCM/ACE solvent medium (50:50 volumetric ratio) to remove the interparticle fluid. The solid is air-dried and then DCM is added to extract the PC and BrPC from the remaining insoluble components. The composition of the liquid in the second extraction is almost pure PC and BrPC. There may be a very small amount of RDP or BPADP, but the peak areas are below the limit of the calibration curves. The solution is 98.6% PC with the balance BrPC based on HPLC results. Other tests including FTIR and ion chromatography showed the material to be free of brominated polycarbonate. Purities >98% of polycarbonates can be repeatedly obtained with this process. The polycarbonate concentration reaches equilibrium within four hours.

The polycarbonate product was precipitated by adding acetone and then filtering the solution through filter paper to collect the white solid.

### Results:

The purity of the product determined by Fourier Transfer Infrared radiation (FTIR) was higher than 99%. The overall mass balance for the process is shown in Table 2. The mass balance on the solids closes. RDP, BPADP, SAN, and a small amount of PC are removed in the first extraction. BrPC and the majority of the PC are removed during the second extraction.

TABLE 2
Mass Balance of extraction procedures.

| | | Amount of | | | | | | | |
|---|---|---|---|---|---|---|---|---|---|
| | | Polymers | Solvent | | Composition (Mass Fraction of Polymers) | | | | |
| | | Relative to | (vol. %) | | | | | Flame | ABS + |
| Stream | Phase | Feed (g) | ACE | DCM | PC | BrPC | SAN | Retardants | others |
| Crude | Solid | 1 | — | | .57 | .02 | .10 | .06 | .25 |
| E1 | Liquid | .17 | 50 | 50 | .05 | 0 | .60 | .35 | 0 |
| F1 | Solid | .83 | — | | — | — | — | — | — |
| E2 | Liquid | .58 | 0 | 100 | .98 | .02 | 0 | 0 | 0 |

| | | | | | | | | |
|---|---|---|---|---|---|---|---|---|
| F2 | Solid | .25 | — | 0 | 0 | 0 | 0 | 1 |

The purity, yield, and solvent consumption for multiple experiments can be seen in Table 3. Larger yields were achieved with smaller scales due to easier filtration using filter paper. The larger scale experiments experienced difficulty with the filter paper clogging and solvent evaporation, which lead to lower yields. The purities have been fairly constant within the limits of the detection method. The second filtration step was replaced with centrifugation to increase the yield to 95% for the larger scale experiment.

TABLE 3
Purity, yield, and solvent consumption over multiple experiments

| | | | Overall | |
|---|---|---|---|---|
| | Final PC | | solvent | |
| | product | Overall | consumption | |
| Exper- | purity* | PC yield | (g solvent/ | |
| iment | (%) | (%) | g PC) | Comments |
| 1 | 98.7 | 98.0 | >100 | Small scale (<0.5 g |
| | | | | product), Solvent use |
| | | | | too high |
| 2 | 98.7 | 92.5 | >100 | Small scale (<0.5 g |
| | | | | product), some product |
| | | | | loss due to filtration |
| | | | | Solvent use too high |
| 3 | 98.6 | 71.0 | 64.3 | Larger scale (~5 g |
| | | | | product) First filtration |
| | | | | had large yield loss, |
| | | | | Solvent use too high |
| 4 | 96.9 | 64.1 | 30.1 | Larger scale (~5 g |
| | | | | product) First |
| | | | | filtration improved, |
| | | | | second filtration |
| | | | | had large yield loss |
| 5 | 97.5 | 95.6 | 29.8 | Larger scale (~9 g) |
| | | | | Replaced second |
| | | | | filtration with |
| | | | | centrifugation. |
| | | | | Acetone was added to |
| | | | | liquid from second |
| | | | | extraction to precipitate |
| | | | | PC. Product filtered from |
| | | | | solution. |

*Only measurable impurity is BrPC, determined by HPLC. Other methods do not show BrPC, indicating a purity over 99%.

### Example 2

### Purification of Trommel Crude Formulations Through Multi-Step Extraction Procedure

### Materials:

A Trommel crude sample was put through the same process as described in EXAMPLE 1 to test the robustness of the extraction process. The Trommel crude sample contains more impurities than the 70% PC crude, including some unknown polymers and dyes. Trommel crude dissolved in DCM is a dark blue color due to the blue color of some of the plastics in the crude.

### Method 1:

The Trommel crude was chopped and sieved to 250-850 micron particles as described in EXAMPLE 1. In the first extraction, the Trommel solid was added to a solution of DCM/ACE (50:50 volumetric ratio) and stirred overnight. A sample of the solution was taken and centrifuged. Unlike the 70% PC crude, the solution from the first extraction separated into four layers: A floating, sticky solid; a clear, blue liquid layer; a slightly foggy, blue liquid layer; and a solid, sand-like layer.

### Method 2:

The Trommel crude was chopped and sieved to 250-850 micron particles as described in EXAMPLE 1. In the first extraction, the Trommel solid was added to DCM and stirred overnight. A sample of the solution was taken and centrifuged. Unlike the 70% PC crude, the solution from the first extraction separated into four layers: A floating, sticky solid; a clear, blue liquid layer; a slightly foggy, blue liquid layer; and a solid, sand-like layer.

### Results:

In the first extraction of Method 1, three of the four unknown polymers were present in the solution. A large amount of PS and SAN was removed, along with the flame retardants and any other low molecular weight polymers or dyes. There appeared to be some partitioning of the different polymers in the two liquid phases, but no high molecular weight PC was present in either phase. A small amount of low molecular weight PC was extracted during the first extraction, similar to the 70 wt. % PC crude. The bottom (PC containing) solid was filtered out and sent on to the second extraction with pure DCM as described in Example 1. In order to purify the PC further after the second extraction, a precipitation step can be added. By adding acetone to the solution from the DCM extraction, PC precipitates and leaves the impurities in solution.

In the first extraction of method 2, the polymers which are insoluble in DCM were removed via centrifugation. The PC contained in the liquid layer was precipitated via the addition of acetone to the liquid material from the first extraction of method 2. Acetone was added to achieve a solvent composed of 50/50 DCM/ACE by volume. The precipitated PC was recovered via filtration and washed with clean 50/50 DCM/ACE. This solid PC product was sent for analysis.

The Trommel product sample of Method 2 was determined to be ˜99% pure based on FTIR, NMR, and hydrolysis HPLC test methods. An impurity was detected by NMR analysis that was estimated to be at a level of ˜1%. Unfortunately, the analytical tests were unable to identify the chemical structure of the impurity.

The uses of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and the foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

What is claimed is:

1. A method for recovering a purified polymer composition, comprising:
contacting a first material including a target polymer for recovery, a first component other than the target polymer, and a second component other than the target polymer, with a first solvent medium under conditions effective to attain a liquid-solid phase separation of the first component from the target polymer and the second component; and
contacting a second material including the target polymer and the second component with a second solvent medium different from the first solvent medium under conditions effective to attain a liquid-solid phase separation of the second component from the target polymer.

2. A method for recovering a purified polymeric composition of a target polycarbonate polymer from a multicomponent polymeric blend material including the target polycarbonate polymer, a first component other than the target polycarbonate polymer, and a second component other than the target polycarbonate polymer, the method comprising:
contacting a first material including the multicomponent polymeric blend material with a first solvent medium in a vessel and under conditions effective to attain a liquid-solid phase separation of the first component from the target polycarbonate polymer and the second component;
contacting a second material including the target polycarbonate polymer and the second component with a second solvent medium different from the first solvent medium in a vessel and under conditions effective to attain a liquid-solid phase separation of the target polycarbonate polymer from the second component; and
recovering the target polycarbonate polymer after the liquid-solid phase separation of the target polycarbonate polymer from the second component.

3. The method of claim 1 wherein the target polymer is a polycarbonate polymer.

4. The method of claim 1, wherein the first material includes a flame retardant, a dye, and a polymer other than the target polymer

5. The method of claim 1, wherein said first component or said second component comprises a mold release agent, a UV stabilizer, a glass, an anti-drip agent, an impact modifier, an antioxidant, a flame retardant synergist, a heat stabilizer, a quencher, a phosphate stabilizer, a pigment, a dye, titanium dioxide, carbon black, talc, or a polymer other than the target polymer.

6. (canceled)

7. The method of claim 1, wherein said target polymer has a weight average molecular weight between about 5,000 Daltons and about 250,000 Daltons.

8. The method of claim 1, wherein said target polymer has a weight average molecular weight between about 10,000 Daltons and about 100,000 Daltons.

9. (canceled)

10. The method of claim 1, wherein the first solvent medium includes dichloromethane, chloroform, carbon tetrachloride, 1,2-ethylene dichloride, 1,1,2,2-tetrachloroethane, chlorobenzene, dibromomethane, or a combination thereof.

11. The method of claim 1, wherein the first solvent medium includes dichloromethane.

12. The method of claim 1, wherein the first solvent medium includes a first organic solvent and a second organic solvent, preferably wherein the first solvent medium is a mixed solvent medium, more preferably wherein the first solvent medium is a binary solvent medium.

13. The method of claim 12, wherein the first organic solvent is a halogenated solvent.

14. The method of claim 13, wherein the first organic solvent is dichloromethane, chloroform, carbon tetrachloride, 1,2-ethylene dichloride, 1,1,2,2-tetrachloroethane, chlorobenzene, or dibromomethane.

15. The method of claim 14, wherein the first organic solvent is dichloromethane.

16. The method of claim 12, wherein the target polymer is less soluble in the second organic solvent than in the first organic solvent.

17. (canceled)

18. The method of claim 12, wherein the second organic solvent is acetone.

19. The method of claim 12, wherein the volumetric ratio of the first organic solvent to the second organic solvent of said first solvent medium is in the range of about 9:1 to about 1:9.

20. (canceled)

21. The method of claim 1, also comprising, after said step of contacting a first material, separating a material including the first component from a material including the target polymer and the second component.

22. (canceled)

23. The method of claim 21, wherein the material including the first component is a liquid material, and the material including the target polymer and the second component is a solid material.

24. The method of claim 21, wherein the material including the first component is a solid material, and the material including the target polymer and the second component is a liquid material.

25. The method of claim 1, also comprising, after said step of contacting a second material, separating a material including the second component from a material including the target polymer.

26. The method of claim 25, wherein said separating includes filtration, flotation, decanting, centrifugation, evaporation, or any combination thereof.

27. The method of claim 25, wherein the material including the second component is a liquid material, and the material including the target polymer is a solid material.

28. The method of claim 25, wherein the material including the second component is a solid material, and the material including the target polymer is a liquid material.

29-30. (canceled)

31. The method of claim 1, wherein the second solvent medium includes dichloromethane.

32. The method of claim 31, wherein the second solvent medium consists essentially of dichloromethane.

33. The method of claim 1, also comprising recovering the target polymer after said step of contacting a second material, wherein said recovering comprises precipitating the target polymer from a liquid fraction in which the target polymer is solvated.

34. The method of claim 33, wherein said precipitating comprises modifying the liquid fraction in which the target polymer is solvated to render the target polymer less soluble therein.

35. The method of claim 34, wherein said modifying comprises adding an anti-solvent for the target polymer to the liquid fraction.

36-37. (canceled)

38. The method of claim 1, wherein said contacting a first material and said contacting a second material steps are performed at temperatures between about 5° C. and about 35° C. and pressures between about 0.5 atmospheres and about 350 atmospheres.

39. The method of claim 38, wherein the temperatures are in the range of about 15° C. to about 30° C. and the pressures are between about 1 atmosphere and 10 atmospheres.

40. The method of claim 1, wherein said contacting a first material and said contacting a second material steps are performed at a temperature within about 10° C. of each other.

41. The method of claim 1, wherein said contacting a first material and said contacting a second material steps are performed at a pressure within 10 atmospheres of each other.

42. The method of claim 1, wherein the first solvent medium dissolves the first component and not the second component or the target polymer.

43. The method of claim 42, wherein the first solvent medium is a mixed solvent medium.

44. The method of claim 1, wherein the first material includes a multicomponent polymer blend material in which the target polymer forms a unitary solid with the first component and the second component.

45. The method of claim 1, wherein the target polymer is a polycarbonate, the first component is a flame retardant or a dye, and the second component is a polymer other than the target polycarbonate.

46. The method of claim 45, wherein the polymer other than the target polycarbonate is a styrene acrylonitrile polymer or an acrylonitrile butadiene styrene polymer.

47. The method of claim 45, wherein the first component is a flame retardant.

48. The method of claim 47, wherein the flame retardant is a bromopolycarbonate, a resorcinol diphenyl phosphate, or a bisphenol-A diphenyl phosphate.

49. A purified polymeric composition prepared by a method according to claim 1.

50. A method for manufacturing a polymeric blend material, comprising preparing a blend of a purified polymeric composition according to claim 48 with at least one additional component.

51. A method for manufacturing a product, comprising shaping a polymeric blend material including a polymeric composition according to claim 49 into an article.

52-85. (canceled)
